(19) United States
(12) Patent Application Publication
(10) Pub. No.: US 2008/0255974 A1
(43) Pub. Date: Oct. 16, 2008

(54) Techniques to manage financial performance data exchange with standard taxonomies

(75) Inventors: Sanjay Jacob, Redmond, WA (US); Marius Ionescu, Bellevue, WA (US); Randy Dong, Issaquah, WA (US); Mark Yang, Sammamish, WA (US); Peter Bull, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/786,488

(22) Filed: Apr. 12, 2007

(51) Int. Cl. G06Q 40/00

(52) U.S. Cl. 705/35

(57) ABSTRACT

Techniques to manage financial performance data are described. An apparatus may include an online analytical processing database with a multidimensional data model, and a business information exchange module communicatively coupled to the online analytical processing database. The business information exchange module may import a taxonomy to the multidimensional data model, create a business model using the multidimensional data model, and export financial data from the business model to an extensible business reporting language instance document. Other embodiments are described and claimed.

### BACKGROUND

Many businesses typically need to define and exchange business and financial performance data. This is typically accomplished through the use of metadata and taxonomies. Taxonomies capture the definition of individual reporting elements as well as the relationships between elements within a given taxonomy and in other taxonomies. In some cases, however, different business entities may use different taxonomies. This makes exchanging business and financial performance data potentially difficult. Furthermore, some governmental agencies require such data to be reported in a standard format, thereby necessitating the conversion of data from a proprietary business format to the standard format. Consequently, there may be a need for improvements to facilitate the exchange of business and financial performance data between different entities and formats in an efficient and cost effective manner.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments may be generally directed to techniques for managing performance and financial data. Some embodiments may be particularly directed to techniques for automatically importing a taxonomy into a multidimensional database. In one embodiment, for example, an apparatus may include an online analytical processing (OLAP) database having a multidimensional data model. A business information exchange module may be communicatively coupled to the OLAP database. The business information exchange module may be arranged to automatically import a taxonomy to the multidimensional data model. The business information exchange module may be used to create a business model using the multidimensional data model. The business information exchange module may automatically export financial data from the business model to a format compatible with the imported taxonomy. In one embodiment, for example, the business information exchange module may export business and financial data from the business model to an extensible business reporting language (XBRL) instance document. In this manner, the business information exchange module and OLAP database may potentially facilitate the exchange of business and financial performance data between different entities and formats in an efficient and cost effective manner. Other embodiments are described and claimed.

### BRIEF DESCRIPTION OF THE DRAWINGS

FIG. 1 illustrates one embodiment of business information exchange system.

FIG. 2 illustrates one embodiment of a first logic flow.

FIG. 3 illustrates one embodiment of a second logic flow.

FIG. 4 illustrates one embodiment of a third logic flow.

FIG. 5 illustrates one embodiment of a computing system architecture.

### DETAILED DESCRIPTION

Various embodiments may comprise one or more elements. An element may comprise any feature, characteristic, structure or operation described in connection with an embodiment. Examples of elements may include hardware elements, software elements, physical elements, or any combination thereof. Although an embodiment may be described with a limited number of elements in a certain arrangement by way of example, the embodiment may include more or less elements in alternate arrangements as desired for a given implementation. It is worthy to note that any references to “one embodiment” or “an embodiment” are not necessarily referring to the same embodiment.

In various embodiments, a business information exchange system may include a computing device having a business information exchange module and an OLAP database. In one embodiment, for example, the business information exchange module may be arranged to export financial data from a business model to an XBRL instance document. This may be accomplished by importing an XBRL taxonomy creating an XBRL hierarchy in the OLAP database. The XBRL hierarchy may be part of an OLAP dimension or XBRL dimension. The business information exchange module may use the XBRL dimension to create an XBRL model (e.g., an OLAP data cube) where data can be added. Once an XBRL model has been created, financial performance data may be added to the XBRL model via a user or automated system. Financial reports may then be created using any number of different types of application programs. The business information exchange module 104 and/or other end-user application programs may be arranged to export financial data from the XBRL model to an XBRL instance document. During export operations the business information exchange module may automatically infer context information for all of the financial data based on the XBRL dimensions used when the report was created. The context information may refer to some combination of dimensions, such as an instant or duration of time, scenario, currency, and so forth.

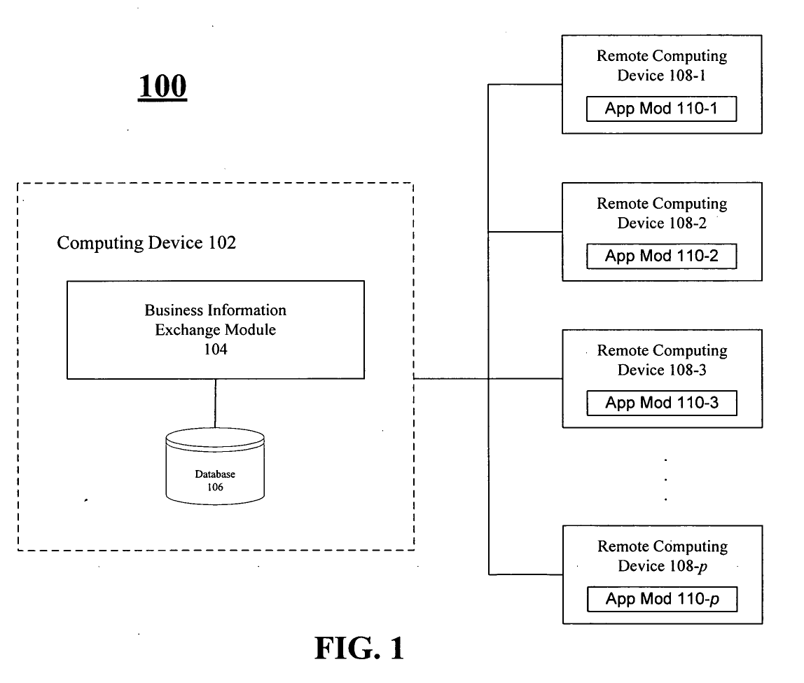

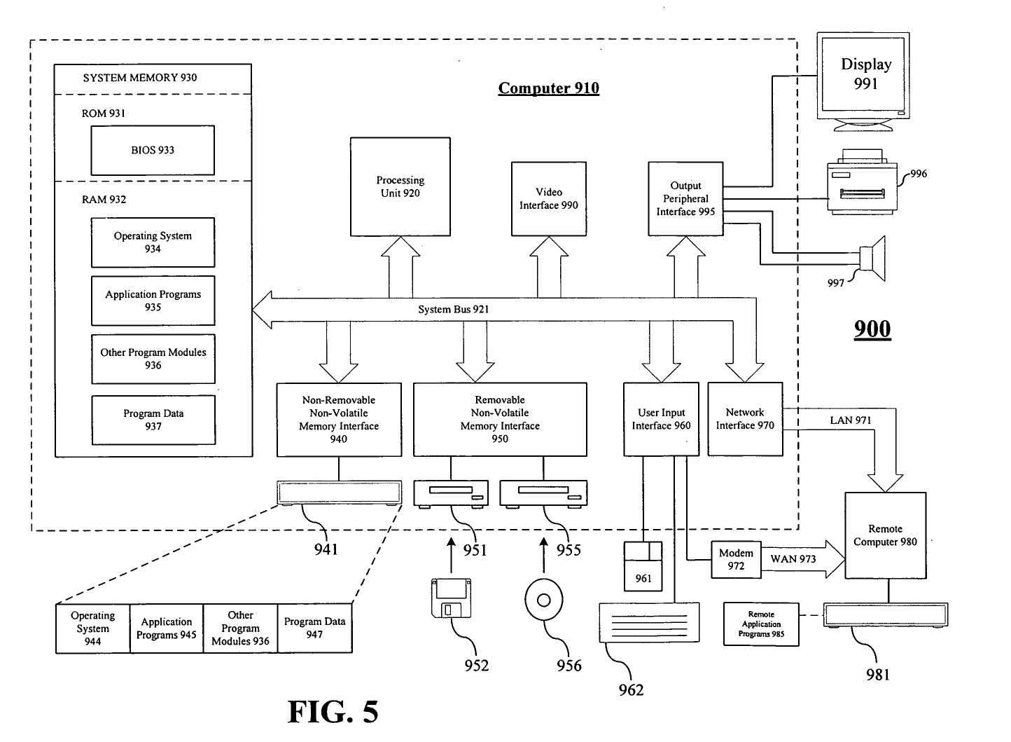

FIG. 1 illustrates a block diagram of a business information exchange system 100. The business information exchange system 100 may represent any system arranged to store, process, communicate, convert, report and otherwise manage business information exchange processes or operations for an electronic system or collection of electronic systems. As shown in FIG. 1, one embodiment of the business information exchange system 100 may include a computing device 102 coupled to one or more remote computing devices 108-1-p, where p represents a positive integer value. Computing device 102 may comprise a business information exchange module 104 communicatively coupled to a database 106. Each of remote computing devices 108-1-p may include a respective application module 110-1-p. In some cases, the modules 104, 110 may be the same or similar modules. In other cases, the modules 104, 110 may be arranged as client-server applications or peer-to-peer applications as desired for a given implementation. Additional details for one embodiment of computing device 102 and remote computing devices 108-1-p may be further illustrated and described with reference to FIG. 5.

As used herein the term “module” may include any structure implemented using hardware elements, software elements, or a combination of hardware and software elements. In one embodiment, for example, the modules described herein are typically implemented as software elements stored in memory and executed by a processor to perform certain defined operations. It may be appreciated that the defined operations, however, may be implemented using more or less modules as desired for a given implementation. It may be further appreciated that the defined operations may be implemented using hardware elements based on various design and performance constraints. The embodiments are not limited in this context.

In various embodiments, the business information exchange system 100 may be used to store, process, communicate, convert, report and otherwise manage business and financial performance data for various types of financial application programs or systems. With respect to computing device 102 and/or remote computing devices 108-1-p, the financial performance data may be stored and accessed via any number of memory units, storage media, machine readable media, or computer-readable media implemented for a given computing device, such as financial database 106 shown with computing device 102, for example. Computing device 102 and remote computing devices 108-1-p may represent any type of electronic device having the appropriate hardware, software or combination hardware and software arranged to execute the operations of business information exchange module 104.

In various embodiments, the computing device 102 may be implemented as a server or cluster of servers. In one embodiment, for example, the computing device 102 may be implemented as a MICROSOFT® OFFICE PERFORMANCEPOINT™ SERVER, Microsoft Corporation, Redmond, Wash. A PerformancePoint Server may comprise a suite of applications, servers, services and tools to manage business information relating to business finances, business management, sales, marketing, manufacturing, human resources, planning, and so forth. A PerformancePoint Server may provide the infrastructure between a PerformancePoint Server client-tier, the PerformancePoint Server (SQL) databases, and other services or endpoints. Although some embodiments may be described in the context of PerformancePoint Servers by way of example, it may be appreciated that various embodiments may be implemented for other computing devices as desired for a given implementation. The embodiments are not limited in this context.

In various embodiments, the remote computing devices 108-1-p may be implemented as client computers for the computing device 102. In one embodiment, for example, the remote computing devices 108-1-p may be implemented as PerformancePoint Server clients. In addition to having the appropriate applications, services and tools to operate as PerformancePoint Server clients, the remote computing devices 108-1-p may include application modules 110-1-p. The application modules 110-1-p may represent application programs suitable for use or interoperability with the business information exchange module 104 as described with reference to the computing device 102. In one embodiment, the application modules 110-1-p may be implemented as an application program from the MICROSOFT OFFICE suite of application programs, such as MICROSOFT EXCEL, for example. The application modules 110-1-p may be described in more detail below.

In various embodiments, the computing device 102 of the business information exchange system 100 may include a database 106. In one embodiment, for example, the database 106 may comprise an enterprise database for a business entity or business model. Further, the database 106 may include a taxonomy and financial performance data for a business entity or business model. The information maintained by the database 106, however, is not necessarily limited by the examples given herein.

In one embodiment, for example, the database 106 may comprise a multidimensional database. More particularly, the database 106 may comprise an online analytical processing (OLAP) database employing a multidimensional data model, thereby allowing for complex analytical and ad-hoc queries with a relatively fast response time. The database 106 may manage an OLAP data cube, which is a conceptual representation of a database which can be implemented in a variety of ways, including top-down, bottom-up, and arrays.

In various embodiments, the OLAP database 106 may include a type library to build various types of models, such as a business model. A business model may comprise a basic unit of data storage in the business information exchange system 100. A business model defines how data from various operational systems are processed, calculated and viewed. A business model may include dimensions and hierarchies, predefined application intelligence, forms, reports, model maps, calculations, processes, business rules, business logic, and so forth. A business model assists in integrating disparate but relevant information about a business entity such as a company into a tangible perspective that can be used to accurately measure such characteristics as performance, plan, budget, forecast, and so forth.

In various embodiments, the OLAP database 106 may implement a multidimensional data model. Multidimensional databases often contain various dimensions. A dimension may represent a fundamental building block to define a metadata structure for a business model. A dimension is an organized hierarchy of categories, or members, that describe data in a fact table. These categories typically describe a similar set of elements. For example, a “Geography” dimension may include Country, Region, State, City or Province. Each dimension is typically made of members. A member represents a specific instance of a characteristic described by a dimension. For example, “Black Roller Pen” could be a member of a “Product” dimension. If a member is calculated, a formula is associated with the member. A property is a characteristic of a dimension member. For example, a characteristic “Color” could be a property of the dimension member “Product.” Properties can be system-designed or user-designed. A hierarchy is a structured organization of dimension members. Hierarchies are typically defined by dimension members, levels, and parent-child relationships.

In various embodiments, the computing device 102 of the business information exchange system 100 may include a business information exchange module 104. The business information exchange module 104 may comprise part of another program (e.g., such as an application program or system program), may comprise part of a library of programs, or may comprise a standalone product. In one embodiment, for example, the business information exchange module 104 may be implemented as part of the PerformancePoint Server architecture, such as part of a PerformancePoint Planning Business Modeler. The embodiments are not limited, however, to this example.

In one embodiment, for example, the business information exchange module 104 may be arranged to store, process and retrieve data from the database 106. More particularly, the business information exchange module 104 may be arranged to automatically import a taxonomy to the multidimensional data model of the database 106. As used herein the term “automatically” refers to reduced or eliminated human intervention. The business information exchange module 104 may create a business model using the multidimensional data model.

In various embodiments, the business information exchange module 104 and/or the application modules 110-1-p may export financial data from the business model to a document having a standardized format. One example of a standard format may include an extensible business reporting language (XBRL) format as defined by the XBRL series of recommendations, such as the XBRL 2.1 Recommendation, Dec. 31, 2003; the XBRL Dimensions 1.0 Recommendation, Sep. 18, 2006; and other progeny and variants (collectively referred to as the “XBRL Recommendations”). The XBRL Recommendations define an emerging extensible markup language (XML)-based standard to define and exchange business and financial performance information. Such exchanges are defined by metadata set out in taxonomies. Taxonomies capture the definition of individual reporting elements as well as the relationships between elements within a taxonomy and in other taxonomies. In some cases, the XBRL format may be required when reporting financial performance information to various governmental agencies, such as the Securities Exchange Commission (SEC), for example.

In various embodiments, the business information exchange module 104 and/or the application modules 110-1-p may be arranged to export financial data from a business model to an XBRL instance document. This may be accomplished by importing an XBRL taxonomy creating an XBRL hierarchy in the OLAP database 106. The XBRL hierarchy may be part of an OLAP dimension or XBRL dimension. An XBRL dimension may refer to the XBRL dimension as defined by the XBRL Recommendations, or the concept of a dimension of type XBRL as used by the MICROSOFT PERFORMANCEPOINT infrastructure, or a combination of both. The business information exchange module may use the XBRL dimension to create an XBRL model where data can be added. In one embodiment, for example, the XBRL model may include the following dimensions: (1) XBRL dimension; (2) time dimension; (3) time data view dimension; (4) currency dimension; (5) scenario dimension; and (6) entity dimension. Other dimensions may be added by a system or a user. Once an XBRL model has been created, financial performance data may be added to the XBRL model via a user or automated system. Financial reports may then be created using any number of different types of application programs, such as a PerformancePoint Planning add-in for MICROSOFT EXCEL. The business information exchange module 104 and/or the application modules 110-1-p may be arranged to export financial data from the XBRL model to an XBRL instance document. During export operations the business information exchange module 104 may automatically infer context information for all of the financial data based on the XBRL dimensions used when the report was created.

Operations for the business information exchange system 100 may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more elements of apparatus 100 or alternative elements as desired for a given set of design and performance constraints.

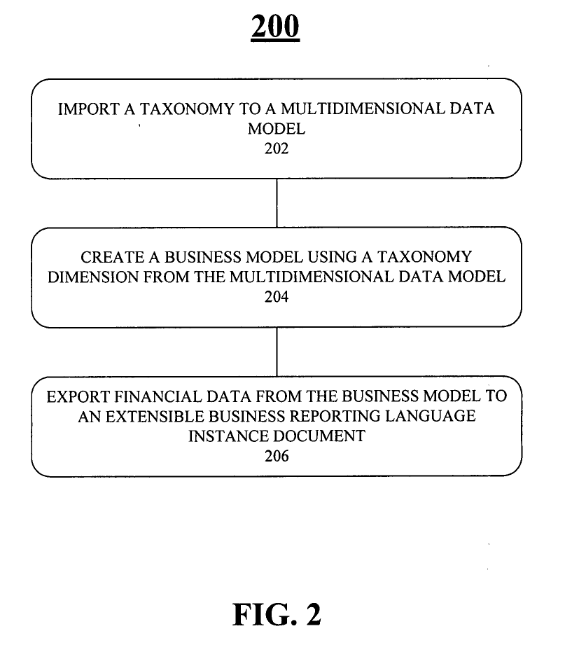

FIG. 2 illustrates a logic flow 200. Logic flow 200 may be representative of the operations executed by one or more embodiments described herein. As shown in FIG. 2, the logic flow 200 may import a taxonomy to a multidimensional data model at block 202. The logic flow 200 may create a business model using a taxonomy dimension from the multidimensional data model at block 204. The logic flow 200 may export financial data from the business model to an extensible business reporting language instance document at block 206. The embodiments are not limited in this context.

In one embodiment, for example, the logic flow 200 may import a taxonomy to a multidimensional data model at block 202. For example, the business information exchange module 104 may load a taxonomy for a given business model, entity, or standard into the OLAP database 106. In one embodiment, the taxonomy may comprise an XBRL taxonomy. The taxonomy may be imported to the OLAP database 106 employing the multidimensional data model. Importing the XBRL taxonomy to the OLAP database 106 using a multidimensional data model may create a hierarchy for the XBRL taxonomy in an OLAP dimension. In one embodiment, for example, the business information exchange module 104 may use the XBRL presentation linkbase to retain the non-numeric, abstract and numeric elements of the XBRL taxonomy, thereby preserving the presentation hierarchy in the XBRL taxonomy. In this manner, the business information exchange module 104 may automatically load a taxonomy in an OLAP hierarchy while reducing or eliminating the need for any manual mapping from a human operator.

In one embodiment, for example, the business information exchange module 104 may load an XBRL taxonomy into a multidimensional data model in accordance with the following pseudo-code:

```
public bool LoadFromXbrlTaxonomy(string xbrlFilePath, string
languageIso)
{
    Using XBRL taxonomy path and language ISO provided by the user
    Parse XBRL taxonomy
    Load root element from taxonomy
    AddXbrlMemberToHierarch(root element, null)
}
public AddXbrlMemberToHierarchy (xbrl element)
{
    if element is of type xbrl then
        if element has already been added to the hierarchy
            skip element
        else if element already exists in XBRL dimension
            use the element from the dimension and add it to the
            hierarchy
        else
            create new element
            add it to the dimension
            add it to the hierarchy
        foreach child of element
            AddXbrlMemberToHierarchy(element.child)
}
```

To uniquely identify each XBRL element, the business information exchange module 104 may use a quantified identifier for each element composed of the following items: (1) an element's namespace; (2) an element's name; and (3) a language ISO.

Once the XBRL taxonomy has been imported into the OLAP database 106, the business information exchange module 104 may create a business model using a taxonomy dimension from the multidimensional data model. A system or user may then begin adding financial performance data to the business model. Once populated with the financial performance data, an XBRL instance document or report may be generated.

To accomplish this, the business information exchange module 104 may perform export operations to export financial data from the business model to a XBRL instance document. In some cases, an application program (e.g., application modules 110-1-p) such as MICROSOFT EXCEL for a client-side device such as remote computing devices 108-1-p may be used to generate a report and export the financial data from the business model to the XBRL instance document. In other cases, an application program (e.g., application modules 110-1-p) such as MICROSOFT EXCEL for a client-side device such as remote computing devices 108-1-p may be used to generate a report, and the business information exchange module 104 of the computing device 102 may export the financial data from the business model to the XBRL instance document.

In one embodiment, for example, the business information exchange module 104 may process a MICROSOFT EXCEL report and obtain an XBRL instance document in accordance with the following pseudo-code:

```
public ProcessCells(ExcelCells cells)
{
        foreach cell in report do
            check if cell contains the following dimensions XBRL, Time, TimeDataView
            using the hierarchy from the XBRL dimension get the XBRL taxonomy associated with
            this report
            get the XBRL element from the taxonomy which is represented in cell
            if XBRL element is abstract
                skip cell
            else if XBRL element is numeric
                if XBRL element is monetary then
                    check that the cell contains the Currency dimension
                    add to the instance document a new numeric element and attach the
                    currency to it
                else
                    add to the instance document a new numeric element
                    extract the annotations for this cell and add them as footnotes to
                    instance document
            else if XBRL element is string
                extract the footnotes for this cell and add them as XBRL string elements to the
                instance document
            get the rest of dimensions from cell (these do not include Time, TimeDataView, Scenario,
            Currency, and XBRL)
                using these dimension create a segment element in the instance document
            get scenario from XBRL cell if it exists
            get start and end dates using Time and TimeDataView from cell
            construct a context using the segment element, scenario and start and end dates
            if context already exists
                skip
            else
                create the context and add it to instance document
            attack context to the element created above
        Export instance document
}
```

In one embodiment, for example, the business information exchange module 104 may generate context information associated with the financial data for the XBRL instance document. As illustrated in the latter portion of the above pseudo-code, the context information for a particular data instance may be inferred in accordance with a set of heuristics or importing rules. For example, if a scenario dimension is present, the business information exchange module 104 may add the scenario member to the context information as follows:

<xbrli:scenario>
<msftPPL:scenarioMember>Actual</msftPPL:scenarioMember>
</xbrli:scenario>

If the entity dimension is present or any other custom dimensions, the business information exchange module 104 may add that information to the segment portion of the context as follows:

```
<xbrli:segment>
  <msftPPL:customDimension>
      <msftPPL:dimension>Entity</msftPPL:dimension>
      <msftPPL:memberId>5004</msftPPL:memberId>
      <msftPPL:memberLabel>Vermont</msftPPL:memberLabel>
  </msftPPL:customDimension>
  [Any other dimensions go here]
</xbrli:segment>
```

If the XBRL member is monetary and a currency dimension is present, the business information exchange module 104 may create an XBRL unit with the correct currency and attach that to the element as follows:

[Currency Unit]
<xbrli:unit id=“USD”>
<xbrli:measure>iso4217:USD</xbrli:measure>
</xbrli:unit>
[Monetary Member referencing the unit]
<usfr-pte:OperatingRevenue id=“data_0”
contextRef=
“From2005-1-2_TO_2005-4-2_Actual_Entity_Vermont”
decimals=“−6”
unitRef=“USD”>9620000000</usfr-pte:OperatingRevenue>

Using the Time Data View and Time dimension, the business information exchange module 104 may infer the start and end date for any context, as follows:

If Time Data View == Periodic
Start Date = first day in the time period
End Date = last day in the time period

For example if Time Period is “Q3 2005,” the start date would be “Jan. 1, 2005” in a fiscal year and the last date would be “Mar. 31, 2005” in a fiscal year.

If Time Data View == YTD
Start Date = first day of the year
End Date = last day in the time period
If Time Data View == ToDate
Start Date = first day the user has in the system [possibly when the
company was founded]
End Date = last day in the time period
If Time Data View == CompareToLastPeriod
Start Date = first day in the previous time period
End Date = last day in the time period
If Time Data View == CompareToLastYear
Start Date = first day in last year
End Date = last day in last year

In one embodiment, for example, the business information exchange module 104 may extract start and end dates using “Time” and “Time Data View” dimensions as previously described in accordance with the following pseudo-code:

```
if (time data view is YEAR TO DATE)
    start date = first date for the year of that time period
    end date = last date in calendar for that time member
else if (time data view is PERIODIC)
    start date = first date in calendar for that time member
    end date = last date in calendar for that time member
else if (time data view is TODATE)
    start date = first date found in the system
    end date = last date in calendar for that time member
else if (time data view is COMPARE TO LAST PERIOD)
    start date = first date in calendar for the previous period time member
    end date = last date in calendar for the previous period time member
else if (time data view is COMPARE TO LAST YEAR)
    start date = first date in calendar for previous year of time member
    end date = last date in calendar for the previous year of time member
```

In various embodiments, the business information exchange module 104 may create a unique identifier (ID) for context information associated with the financial data for the XBRL instance document. Once the context information has been generated, the business information exchange module 104 may create a unique ID for the context information which incorporates all of the dimensions. The business information exchange module 104 may assign the unique ID to the instance data. In some cases, multiple instance data can share the same context.

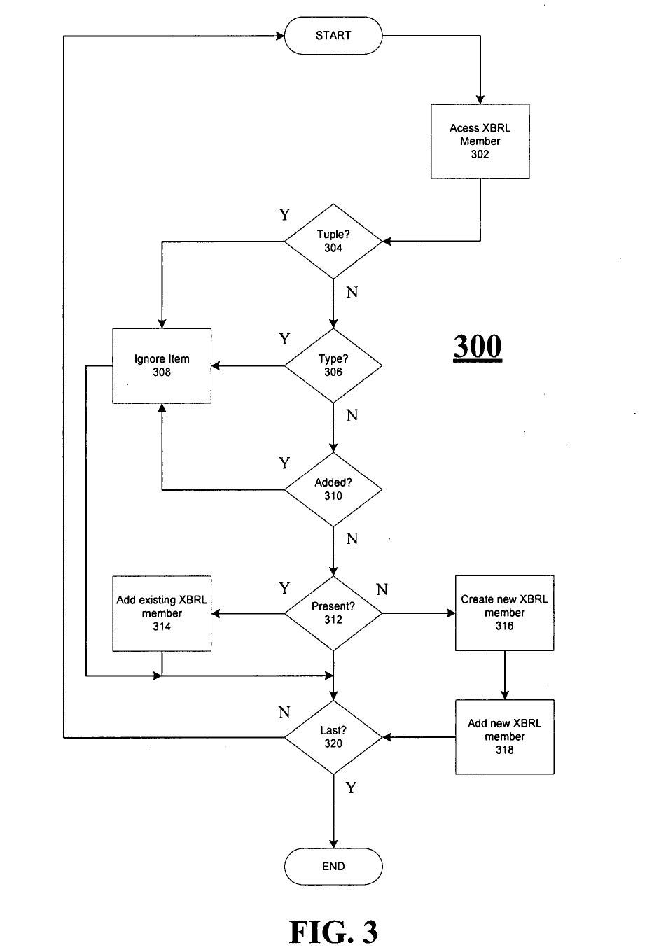

FIG. 3 illustrates a logic flow 300. The logic flow 300 provides an example of an XBRL taxonomy loader implemented as part of the business information exchange module 104 of the computing device 102. As shown in FIG. 3, the logic flow 300 may access an XBRL member at block 302. The logic flow 300 may determine whether the XBRL member is a tuple at diamond 304. If the XBRL member is a tuple, then the XBRL member is ignored at block 308. If the XBRL member is not a tuple, then a determination is made whether the XBRL member is an item of the type fractionitem type at diamond 306. The XBRL taxonomy loader does not typically import items of the fractionitem type. The fractionitem type is relatively rare, and many XBRL taxonomies do not have XBRL members of this type.

If the XBRL member is not afractionitem type, then a determination is made whether the XBRL member has been added to the member set at diamond 310. An XBRL member is uniquely identified by the namespace and XBRL name. If the XBRL member has been added to the member set, then the XBRL member is ignored at block 308. If the XBRL member has not been added to the member set, then a determination is made whether the XBRL member is already in the XBRL dimension at diamond 312.

If the XBRL member is already in the XBRL dimension, then the existing XBRL member is added from the XBRL dimension to the member set at block 314. If the XBRL member is not in the XBRL dimension, then a new XBRL member is created in the XBRL dimension at block 316. The newly created XBRL member is added to the member set at block 318. A determination is made whether the XBRL member is the last member in the XBRL taxonomy at diamond 320. If the XBRL member is the last member in the XBRL taxonomy, then the logic flow 300 terminates. If the XBRL member is not the last member in the XBRL taxonomy, then the logic flow 300 begins again.

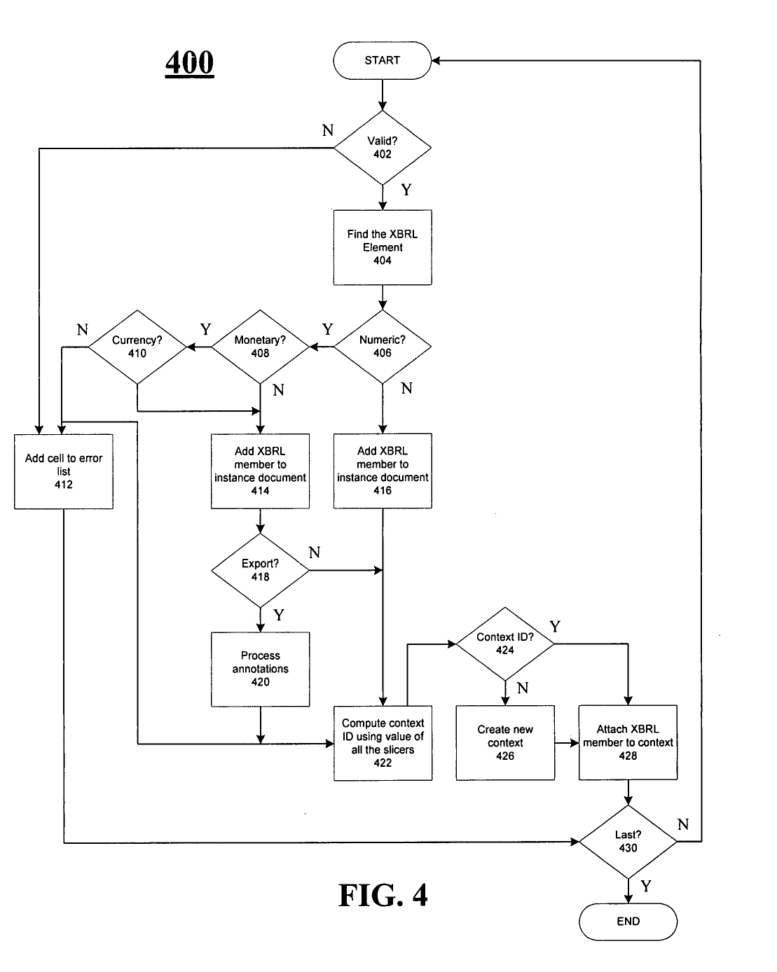

FIG. 4 illustrates a logic flow 400. The logic flow 400 provides an example of exporting a cell, range of cells, or entire PerformancePoint matrices, using an XBRL dimension and using a PerformancePoint Planning Excel Add-In module for MICROSOFT EXCEL. As shown in FIG. 4, the logic flow 400 determines whether a cell is valid at diamond 402. In one embodiment, for example, a valid cell must be part of a matrix and the matrix must contain at least the following dimensions: (1) the XBRL dimension; (2) the Time dimension; and (3) the Time Data View dimension. If the cell is not a valid cell, then the logic flow 400 adds the cell to the error list at block 412. If the cell is a valid cell, then the logic flow 400 finds the XBRL element from the cell's XBRL slicer in the taxonomy at block 404.

The logic flow 400 may determine whether the XBRL member is numeric at diamond 406. If the XBRL member is numeric, then a determination is made whether the XBRL member is monetary at diamond 408. If the XBRL member is monetary, then a determination is made whether the currency dimension is specified in the matrix at diamond 410.

If the currency dimension is not specified in the matrix, then the logic flow 400 adds the cell to the error list at block 412. The logic flow 400 computes a context ID using a value from all the slicers at block 422. The logic flow 400 determines whether there is a context ID in the system at diamond 424. If there is no context ID in the system, then the logic flow 400 creates a new context at block 426, and the logic flow 400 attaches the XBRL member to the context at block 428. If there is a context ID in the system, then the logic flow 400 attaches the XBRL member to the context at block 428. Once the XBRL member is attached to the context, the logic flow 400 determines whether the last selected cell has been reached at diamond 430. If the last selected cell has been reached, then the logic flow 400 terminates. If the last selected cell has not been reached, then the logic flow 400 is repeated.

If the XBRL member is not monetary as determined at diamond 408, then the logic flow 400 adds the XBRL member to the instance document. The data comes from the numeric value in the cell. A determination is made whether to export annotations at diamond 418. This may be accomplished, for example, by checking whether the feature “Export Annotations” has been checked in the user interface for the wizard. If the logic flow 400 is to export annotations, then the logic flow 400 processes any annotations for the cell as footnotes at block 420, and control is passed to block 422. If the logic flow is not to export annotations, then control is passed directly to block 422 and the operations of block 420 are omitted.

If the XBRL member is not numeric as determined at diamond 406, then the logic flow 400 adds the XBRL member to the instance document. The data comes from the value in the annotation. The logic flow then passes control to block 422.

Some embodiments may be further described by way of example. Assume the computing device 102 is a PerformancePoint Server implementing the business information exchange module 104 as part of a PerformancePoint Planning Business Modeler. Further assume that the remote computing device 108-1 is a PerformancePoint Server client in communication with the computing device 102, and the application module 110-1 is a MICROSOFT EXCEL application program having a PerformancePoint Planning Excel Add-In module. The business information exchange module 104 may include an XBRL taxonomy loader wizard that allows a user to import an XBRL taxonomy into the PerformancePoint system. The XBRL model with the newly created XBRL dimension gets deployed to an application system. The application module 110-1 implemented as a MICROSOFT EXCEL application program may pull data from the application system and creates a financial performance report. The application module 110-1 may use the PerformancePoint Planning Excel Add-In module and an XBRL Instance Document Wizard to allow a user to export any report that uses the XBRL dimension.

FIG. 5 illustrates a block diagram of a computing system architecture 900 suitable for implementing various embodiments, including the business information exchange system 100. It may be appreciated that the computing system architecture 900 is only one example of a suitable computing environment and is not intended to suggest any limitation as to the scope of use or functionality of the embodiments. Neither should the computing system architecture 900 be interpreted as having any dependency or requirement relating to any one or combination of components illustrated in the exemplary computing system architecture 900.

Various embodiments may be described in the general context of computer-executable instructions, such as program modules, being executed by a computer. Generally, program modules include any software element arranged to perform particular operations or implement particular abstract data types. Some embodiments may also be practiced in distributed computing environments where operations are performed by one or more remote processing devices that are linked through a communications network. In a distributed computing environment, program modules may be located in both local and remote computer storage media including memory storage devices.

As shown in FIG. 5, the computing system architecture 900 includes a general purpose computing device such as a computer 910. The computer 910 may include various components typically found in a computer or processing system. Some illustrative components of computer 910 may include, but are not limited to, a processing unit 920 and a memory unit 930.

In one embodiment, for example, the computer 910 may include one or more processing units 920. A processing unit 920 may comprise any hardware element or software element arranged to process information or data. Some examples of the processing unit 920 may include, without limitation, a complex instruction set computer (CISC) microprocessor, a reduced instruction set computing (RISC) microprocessor, a very long instruction word (VLIW) microprocessor, a processor implementing a combination of instruction sets, or other processor device. In one embodiment, for example, the processing unit 920 may be implemented as a general purpose processor. Alternatively, the processing unit 920 may be implemented as a dedicated processor, such as a controller, microcontroller, embedded processor, a digital signal processor (DSP), a network processor, a media processor, an input/output (I/O) processor, a media access control (MAC) processor, a radio baseband processor, a field programmable gate array (FPGA), a programmable logic device (PLD), an application specific integrated circuit (ASIC), and so forth. The embodiments are not limited in this context.

In one embodiment, for example, the computer 910 may include one or more memory units 930 coupled to the processing unit 920. A memory unit 930 may be any hardware element arranged to store information or data. Some examples of memory units may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), EEPROM, Compact Disk ROM (CD-ROM), Compact Disk Recordable (CD-R), Compact Disk Rewriteable (CD-RW), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk (e.g., floppy disk, hard drive, optical disk, magnetic disk, magneto-optical disk), or card (e.g., magnetic card, optical card), tape, cassette, or any other medium which can be used to store the desired information and which can accessed by computer 910. The embodiments are not limited in this context.

In one embodiment, for example, the computer 910 may include a system bus 921 that couples various system components including the memory unit 930 to the processing unit 920. A system bus 921 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, and so forth. The embodiments are not limited in this context.

In various embodiments, the computer 910 may include various types of storage media. Storage media may represent any storage media capable of storing data or information, such as volatile or non-volatile memory, removable or non-removable memory, erasable or non-erasable memory, writeable or re-writeable memory, and so forth. Storage media may include two general types, including computer readable media or communication media. Computer readable media may include storage media adapted for reading and writing to a computing system, such as the computing system architecture 900. Examples of computer readable media for computing system architecture 900 may include, but are not limited to, volatile and/or nonvolatile memory such as ROM 931 and RAM 932. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio-frequency (RF) spectrum, infrared and other wireless media. Combinations of the any of the above should also be included within the scope of computer readable media.

In various embodiments, the memory unit 930 includes computer storage media in the form of volatile and/or nonvolatile memory such as ROM 931 and RAM 932. A basic input/output system 933 (BIOS), containing the basic routines that help to transfer information between elements within computer 910, such as during start-up, is typically stored in ROM 931. RAM 932 typically contains data and/or program modules that are immediately accessible to and/or presently being operated on by processing unit 920. By way of example, and not limitation, FIG. 5 illustrates operating system 934, application programs 935, other program modules 936, and program data 937.

The computer 910 may also include other removable/non-removable, volatile/nonvolatile computer storage media. By way of example only, FIG. 5 illustrates a hard disk drive 940 that reads from or writes to non-removable, nonvolatile magnetic media, a magnetic disk drive 951 that reads from or writes to a removable, nonvolatile magnetic disk 952, and an optical disk drive 955 that reads from or writes to a removable, nonvolatile optical disk 956 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 941 is typically connected to the system bus 921 through a non-removable memory interface such as interface 940, and magnetic disk drive 951 and optical disk drive 955 are typically connected to the system bus 921 by a removable memory interface, such as interface 950.

The drives and their associated computer storage media discussed above and illustrated in FIG. 5, provide storage of computer readable instructions, data structures, program modules and other data for the computer 910. In FIG. 5, for example, hard disk drive 941 is illustrated as storing operating system 944, application programs 945, other program modules 946, and program data 947. Note that these components can either be the same as or different from operating system 934, application programs 935, other program modules 936, and program data 937. Operating system 944, application programs 945, other program modules 946, and program data 947 are given different numbers here to illustrate that, at a minimum, they are different copies. A user may enter commands and information into the computer 910 through input devices such as a keyboard 962 and pointing device 961, commonly referred to as a mouse, trackball or touch pad. Other input devices (not shown) may include a microphone, joystick, game pad, satellite dish, scanner, or the like. These and other input devices are often connected to the processing unit 920 through a user input interface 960 that is coupled to the system bus, but may be connected by other interface and bus structures, such as a parallel port, game port or a universal serial bus (USB). A monitor 991 or other type of display device is also connected to the system bus 921 via an interface, such as a video interface 990. In addition to the monitor 991, computers may also include other peripheral output devices such as speakers 997 and printer 996, which may be connected through an output peripheral interface 990.

The computer 910 may operate in a networked environment using logical connections to one or more remote computers, such as a remote computer 980. The remote computer 980 may be a personal computer (PC), a server, a router, a network PC, a peer device or other common network node, and typically includes many or all of the elements described above relative to the computer 910, although only a memory storage device 981 has been illustrated in FIG. 5 for clarity. The logical connections depicted in FIG. 5 include a local area network (LAN) 971 and a wide area network (WAN) 973, but may also include other networks. Such networking environments are commonplace in offices, enterprise-wide computer networks, intranets and the Internet.

When used in a LAN networking environment, the computer 910 is connected to the LAN 971 through a network interface or adapter 970. When used in a WAN networking environment, the computer 910 typically includes a modem 972 or other technique suitable for establishing communications over the WAN 973, such as the Internet. The modem 972, which may be internal or external, may be connected to the system bus 921 via the user input interface 960, or other appropriate mechanism. In a networked environment, program modules depicted relative to the computer 910, or portions thereof, may be stored in the remote memory storage device. By way of example, and not limitation, FIG. 5 illustrates remote application programs 985 as residing on memory device 981. It will be appreciated that the network connections shown are exemplary and other techniques for establishing a communications link between the computers may be used. Further, the network connections may be implemented as wired or wireless connections. In the latter case, the computing system architecture 900 may be modified with various elements suitable for wireless communications, such as one or more antennas, transmitters, receivers, transceivers, radios, amplifiers, filters, communications interfaces, and other wireless elements. A wireless communication system communicates information or data over a wireless communication medium, such as one or more portions or bands of RF spectrum, for example. The embodiments are not limited in this context.

Some or all of the business information exchange system 100 and/or computing system architecture 900 may be implemented as a part, component or sub-system of an electronic device. Examples of electronic devices may include, without limitation, a processing system, computer, server, work station, appliance, terminal, personal computer, laptop, ultra-laptop, handheld computer, minicomputer, mainframe computer, distributed computing system, multiprocessor systems, processor-based systems, consumer electronics, programmable consumer electronics, personal digital assistant, television, digital television, set top box, telephone, mobile telephone, cellular telephone, handset, wireless access point, base station, subscriber station, mobile subscriber center, radio network controller, router, hub, gateway, bridge, switch, machine, or combination thereof. The embodiments are not limited in this context.

In some cases, various embodiments may be implemented as an article of manufacture. The article of manufacture may include a storage medium arranged to store logic and/or data for performing various operations of one or more embodiments. Examples of storage media may include, without limitation, those examples as previously provided for the memory unit 130. In various embodiments, for example, the article of manufacture may comprise a magnetic disk, optical disk, flash memory or firmware containing computer program instructions suitable for execution by a general purpose processor or application specific processor. The embodiments, however, are not limited in this context.

Various embodiments may be implemented using hardware elements, software elements, or a combination of both. Examples of hardware elements may include any of the examples as previously provided for a logic device, and further including microprocessors, circuits, circuit elements (e.g., transistors, resistors, capacitors, inductors, and so forth), integrated circuits, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method, comprising:
importing a taxonomy to a multidimensional data model;
creating a business model using a taxonomy dimension from said multidimensional data model; and
exporting financial data from said business model to an extensible business reporting language instance document.

2. The method of claim 1, comprising importing an extensible business reporting language taxonomy to said multidimensional data model.

3. The method of claim 1, comprising importing said taxonomy to an online analytical processing database having said multidimensional data model.

4. The method of claim 1, comprising creating a hierarchy for said taxonomy in an online analytic processing dimension.

5. The method of claim 1, comprising retaining non-numeric, abstract and numeric elements from said taxonomy to preserve a presentation hierarchy for said taxonomy.

6. The method of claim 1, comprising generating context information associated with said financial data for said extensible business reporting language instance document.

7. The method of claim 1, comprising creating a unique identifier for context information associated with said financial data for said extensible business reporting language instance document.

8. An article comprising a storage medium containing instructions that if executed enable a system to:
import a taxonomy to a multidimensional data model to create a taxonomy dimension;
create a business model using said taxonomy dimension; and
export financial data from said business model to an extensible business reporting language instance document.

9. The article of claim 8, further comprising instructions that if executed enable the system to import an extensible business reporting language taxonomy to said multidimensional data model.

10. The article of claim 8, further comprising instructions that if executed enable the system to import said taxonomy to an online analytical processing database having said multidimensional data model.

11. The article of claim 8, further comprising instructions that if executed enable the system to create a hierarchy for said taxonomy in an online analytic processing dimension.

12. The article of claim 8, further comprising instructions that if executed enable the system to retain non-numeric, abstract and numeric elements from said taxonomy to preserve a presentation hierarchy for said taxonomy.

13. The article of claim 8, further comprising instructions that if executed enable the system to generate context information associated with said financial data for said extensible business reporting language instance document.

14. The article of claim 8, further comprising instructions that if executed enable the system to create a unique identifier for context information associated with said financial data for said extensible business reporting language instance document.

15. An apparatus comprising:
an online analytical processing database with a multidimensional data model; and
a business information exchange module communicatively coupled to said online analytical processing database, said business information exchange module to import a taxonomy to said multidimensional data model, create a business model using said multidimensional data model, and export financial data from said business model to an extensible business reporting language instance document.

16. The apparatus of claim 15, said business information exchange module to import an extensible business reporting language taxonomy to said multidimensional data model to create an extensible business reporting language taxonomy dimension of said multidimensional data model.

17. The apparatus of claim 15, said business information exchange module to create a hierarchy for said taxonomy in an online analytic processing dimension.

18. The apparatus of claim 15, said business information exchange module to generate context information associated with said financial data for said extensible business reporting language instance document.

19. The apparatus of claim 15, said business information exchange module to create a unique identifier for context information associated with said financial data for said extensible business reporting language instance document.

20. The apparatus of claim 15, comprising an application module to retrieve said financial data for said business model from said business information exchange module over a network, create a report using said financial data, and convert said report to said extensible business reporting language instance document.
